(19) United States
(12) Patent Application Publication
(10) Pub. No.: US 2005/0045347 A1
(43) Pub. Date: Mar. 3, 2005

(54) Portable handheld work apparatus

(76) Inventors: Thomas Stark, Waiblingen (DE); Michael Vogtle, Esslingen (DE); Bastian Vogt, Karlsruhe (DE)

Correspondence Address: Walter Ottesen;Patent Attorney, P.O. Box 4026, Gaithersburg, MD, 20885-4026, US

(21) Appl. No.: 10/687,884

(22) Filed: Oct. 20, 2003

(30) Foreign Application Priority Data
Oct. 18, 2002 (DE) 102 48 642.5

(51) Int. Cl. A01B 33/00

(52) U.S. Cl. 172/42

(57) ABSTRACT

A portable handheld work apparatus such as a sweeper, motorized cultivator or the like has a drive motor (3), a work tool, which is driven by the drive motor (3), and at least one transport wheel (13). The transport wheel (13) is fixed to the work apparatus via at least two struts (14, 15). A first strut (14) is rotatably mounted on the work apparatus at the end (19) of the strut facing away from the transport wheel (13) and a second strut (15) can be fixed with its end (20) to at least two attachment points (17, 18) on the work apparatus with the end (20) facing away from the transport wheel (13).

### FIELD OF THE INVENTION

The invention relates to a portable handheld work apparatus such as a sweeper, cultivator or the like.

### BACKGROUND OF THE INVENTION

A portable handheld work apparatus is known from U.S. Pat. No. 6,415,588. The work apparatus described in this patent includes a drive motor for driving a work tool. Two wheels are foldably fixed on the work apparatus and are arranged on an axle. The folding mechanism is defined by two sheet metal parts which are pivotable toward each other and are held in end positions via a tension spring. The transport wheel is fixedly connected to the frame of the work apparatus.

### SUMMARY OF THE INVENTION

It is an object of the invention to provide a work apparatus of the kind described above which has a robust, adjustable transport wheel. Furthermore, the invention is based on a transport arrangement which can be retrofitted to a work apparatus.

The portable handheld work apparatus arrangement of the invention includes: a work apparatus including a drive motor and a work tool driven by the drive motor; at least one transport wheel; first and second struts for connecting the transport wheel to the work apparatus; the first strut having a first end facing away from the transport wheel and the first strut being rotatably mounted on the work apparatus at the first end; and, the second strut having a first end facing away from the transport wheel and the second strut being fixable at the first end thereof on the work apparatus at at least first and second attachment points.

A transport wheel is provided for the portable handheld work apparatus which is fixed on the work apparatus by at least two struts. In this way, a stable fixation of the transport wheel on the work apparatus is achieved. In order to be able to change the position of the transport wheel relative to the work apparatus, it is provided that the transport wheel is rotatably supported on the work apparatus via the first strut; whereas, the second strut can be fixed in at least two attachment points on the work apparatus.

It is practical when the two attachment points are at different distances to the rotational axis of the first strut. In this way, the transport wheel has distances from the work apparatus which are different in the two attachment points of the second strut. Advantageously, when the second strut is mounted in the first attachment point, the transport wheel is arranged in the region of the frame of the work apparatus. The transport wheel is not used in this position. The work apparatus can be used unhindered by the transport wheel. Here, the work tool is in contact engagement with the ground and the apparatus is held by an operator at the end lying opposite the work tool. Advantageously, the transport wheel is at a distance from the frame of the work apparatus when the second strut is arranged in the second attachment point. In this position, the transport wheel comes in contact engagement with the ground. By tilting the work apparatus about the transport wheel, the work apparatus can be transported without the work tool contacting the ground. At the same time, the operator must not lift the work apparatus. The transport wheel thereby makes possible a simple transport of the work apparatus.

A simple adjustment of the position of the second strut on the work apparatus can be achieved in that the attachment points are configured as detent recesses. The first attachment point is configured as a detent recess closed toward the strut. With the second strut disposed at the first attachment point, the transport wheel is not in contact engagement with the ground. In this way, the weight of the transport wheel acts on the strut and therefore in the detent recess. In that the detent recess is closed toward the strut, it is ensured that the transport wheel is securely held in the region of the work apparatus. For the second attachment point, it is provided that this detent recess is configured open toward the strut. The transport wheel is in contact engagement with the ground when the second strut is disposed in a second attachment point. A force from the ground acts via the second strut on the detent recess. Because of the detent recess, which is open toward the strut, the strut can be removed from the detent recess easily when load is removed from the transport wheel. At the same time, a secure holding of the strut in the detent recess is ensured during operation with the detent recess being closed toward the strut. A bolt is arranged on the second strut and extends transversely to the strut. The bolt and the detent recesses coact. The bolt operates together with an attachment screw. In this way, the second strut can be additionally fixed in a detent recess.

The detent recesses are advantageously formed in a rail fixed on the work apparatus. The rail and the first strut are releasably fixed to the work apparatus. In this way, the transport wheel can be disassembled in a simple manner from the work apparatus. At the same time, a retrofit of the transport wheel is easily possible for existing work apparatus. In order to adapt the position of the transport wheel to the particular requirements, it is provided that several second attachment points are provided at different distances from the rotational axis of the first strut. The distance of the transport wheel from the work apparatus can be varied by the selection of the attachment point. In order to achieve a high stability, two transport wheels are provided which are mounted on a common axle. The axle is held by two first struts and a second strut.

A transport arrangement can be retrofitted to a portable handheld work apparatus and includes at least a transport wheel which is fixed on at least a first strut and on at least a second strut. A rail having at least two attachment points is mounted on the end of the second strut facing away from the transport wheel. For retrofitting the transport wheel to a work apparatus, the rail must only be fixed to the work apparatus and the first strut is fixed rotatably on the work apparatus. In this way, a simple assembly and disassembly of the transport arrangement is provided.

The attachment points are especially configured as detent recesses. An attachment bolt is arranged on the end of the first strut facing away from the transport wheel. The rail includes a detent recess which is closed toward the second strut and several detent recesses which are open toward the second strut.

### BRIEF DESCRIPTION OF THE DRAWINGS

The invention will now be described with reference to the drawings wherein:

FIG. 1 is a side elevation view of a work apparatus in the form of a sweeper;

FIG. 2 is an enlarged view of the transport wheel of the work apparatus of FIG. 1;

FIG. 3 is a side elevation view of the work apparatus of FIG. 1 wherein the transport wheel is in another position;

FIG. 4 is an enlarged detail view of the transport wheel of FIG. 3;

FIG. 5 is a side elevation view of the work apparatus of FIG. 1 showing a further position of the transport wheel;

FIG. 6 is an enlarged view of the transport wheel of FIG. 5;

FIG. 7 is a further view of the section of the transport wheel shown in FIG. 6; and,

FIG. 8 is a perspective view of a transport arrangement.

### DESCRIPTION OF THE PREFERRED EMBODIMENTS OF THE INVENTION

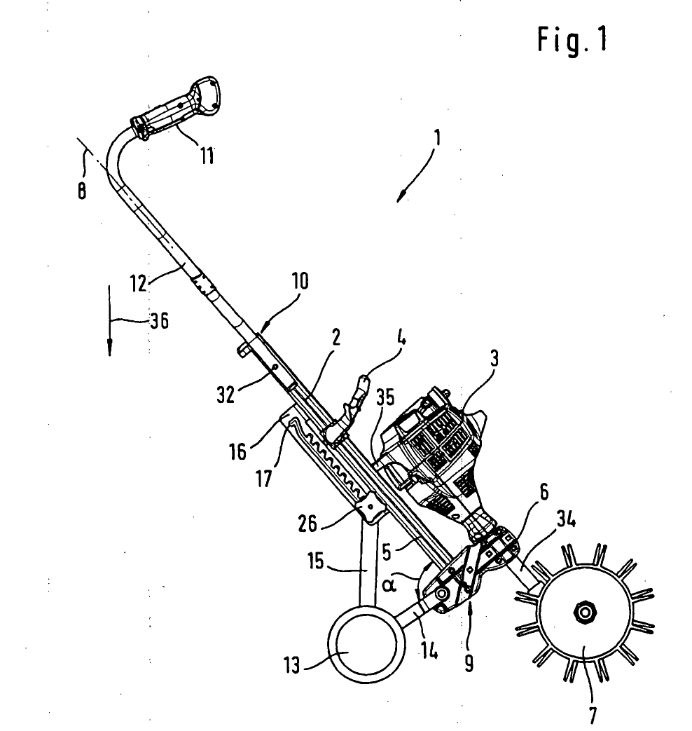

In FIG. 1, a portable handheld work apparatus in the form of a sweeper 1 is shown. The sweeper 1 has a frame 2 which is formed from a rod 5 as well as a mount 6. The rod 5 extends approximately in the longitudinal direction 8 of the sweeper 1. The mount 6 is mounted at a first end 9 of the frame 2 and extends approximately perpendicular to the rod 5. A drive shaft 34 of a drive motor 3 extends through the mount 6. The drive motor 3 is supported with a support 35 on the frame 2. A drum 7 having sweep bristles is mounted on the end of the mount 6 lying opposite to the drive motor 3. The drum is rotatably driven by the drive shaft 34.

At the second end 10 of the frame 2, which faces away from the first end 9, two symmetrically configured handle tubes 12 are mounted which carry respective handles 11. In FIG. 1, only one of the handle tubes 12 is shown. In the work position of the sweeper 1 shown in FIG. 1, the handles 11 are inclined toward the frame 2. The handles 11 and the acting direction 36 of the gravity force conjointly define an angle. The handle tubes 12 are fixed on the frame 2 via a fixing or locking device 32. The locking device is releasable so that the handle tubes 12 with the handles 11 can be folded toward the frame 2 of the sweeper 1. A handle 4 is attached to the frame 2 between the drive motor 3 and the handle tubes 12 for transporting the sweeper 1 in the folded-over state.

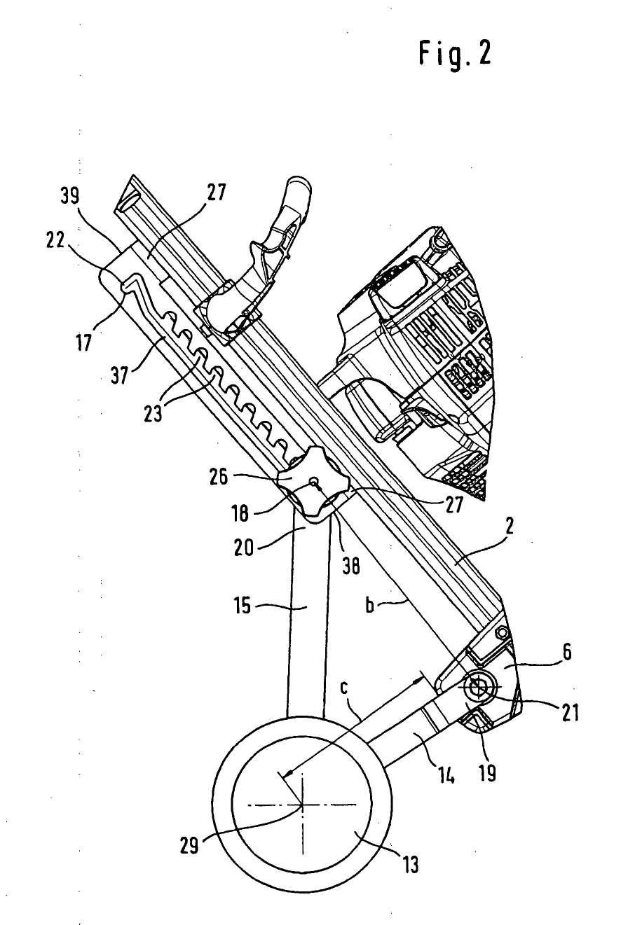

Two symmetrically arranged transport wheels 13 are fixed on the sweeper 1 of which one is shown enlarged in FIG. 2. The transport wheels 13 are fixed on the frame 2 by two first struts 14 (only one of which is shown) and a second strut 15. It can be practical to provide one or several transport wheels 13 and one or several first struts 14 as well as one or several second struts 15. The struts 14 and 15 are rotatably supported about the rotational axis 29 of the transport wheel 13 on the end facing toward the transport wheel 13. The first strut 14 is attached rotatably to the mount 6 at its first end 19 facing away from the transport wheel 13. The first strut 14 is therefore rotatable about the rotational axis 21. The second strut 15 is fixed at its end 20 to a rail 16 fixed to the frame 2 with the end 20 facing away from the transport wheel 13. The rail 16 extends in the longitudinal direction 8 of the sweeper 1. At its two ends, the rail 16 is fixed via brackets 27 to the rod 5 of the frame 2.

The rail 16 has a slot 37 running in its longitudinal direction. Starting from the end 38, which faces toward the first end 9 of the frame 2, the rail 16 includes second detent recesses 23 at equal spacings one from the other. These detent recesses extend upwardly starting from the slot 37, that is, against the acting direction 36 of the gravity force and these detent recesses 23 are open toward the slot 37. At the end 39 of the rail 16, which faces toward the second end 10 of the frame 2, a first detent recess 22 is arranged which is closed in a direction toward the strut 15. The slot 37 opens into the detent recess 22 at the end which lies opposite to the acting direction 36 of the gravity force in the work position.

At the end 20 of the second strut 15, a fixing screw 26 is mounted whose threaded bolt extends transversely to the strut 15. The strut 15 is fixed at a second attachment point 18 to the rail 16. For this purpose, the threaded bolt is arranged in the detent recess 23 lying next to the end 38 and is fixed in this position by the fixing screw 26. In the position shown in FIGS. 1 and 2, the rotational axis 29 of the transport wheel 13 has a maximum distance (c) to the frame 2. The second attachment point 18 lies at a distance (b) to the rotational axis 21 of the first strut 14. The first strut 14 and the frame 2 conjointly define an angle α which can, for example, be approximately 90°.

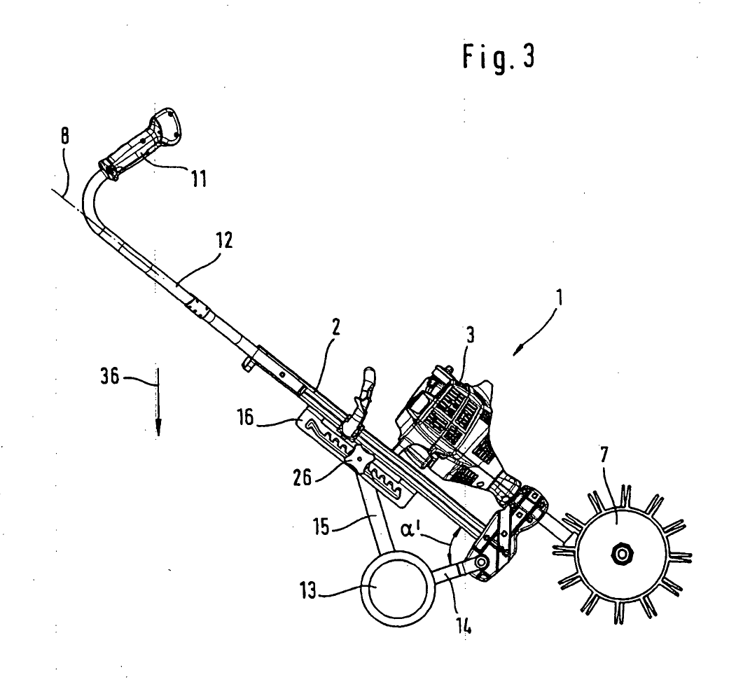

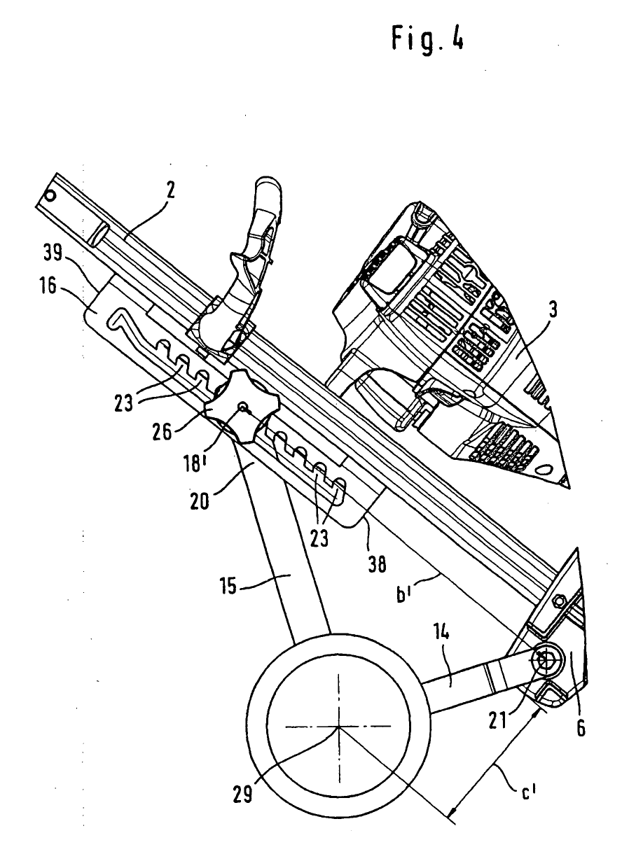

In FIGS. 3 and 4, the second strut 15 is disposed in a detent recess 23 which is approximately midway between the ends 38 and 39 of the rail 16. The end 20 of the second strut 15 is fixed on a second attachment point 18′ by the attachment screw 26. The first strut 14 and the frame 2, which lies in the longitudinal direction 8 of the sweeper 1, conjointly define an angle α′ which is less than the angle α shown in FIGS. 1 and 2. The inclination angle between the second strut 15 and the frame 2 is also flatter than in FIGS. 1 and 2. The rotational axis 29 of the transport wheel 13 is at a distance (c′) to the mount 6 of the frame 2 and the distance (c′) is less than the distance (c) shown in FIGS. 1 and 2. The distance (b′) between the rotational axis 21 and the attachment point 18′ is, however, greater than the distance (b) in FIGS. 1 and 2. If the transport wheel 13 comes into contact engagement with the ground in the position shown in FIG. 3, then the longitudinal direction 8 of the sweeper 1 runs flatter than in FIGS. 1 and 2. With the selection of the attachment point 18, the distance of the transport wheel 13 to the frame 2 and therefore the position of the sweeper 1 and especially of the handles 11 can be varied and thereby be adapted to the operator. With force on the handles 11 in the acting direction 36 of the gravity force, the drum 7 can be raised from the ground so that the sweeper 1 can be easily transported.

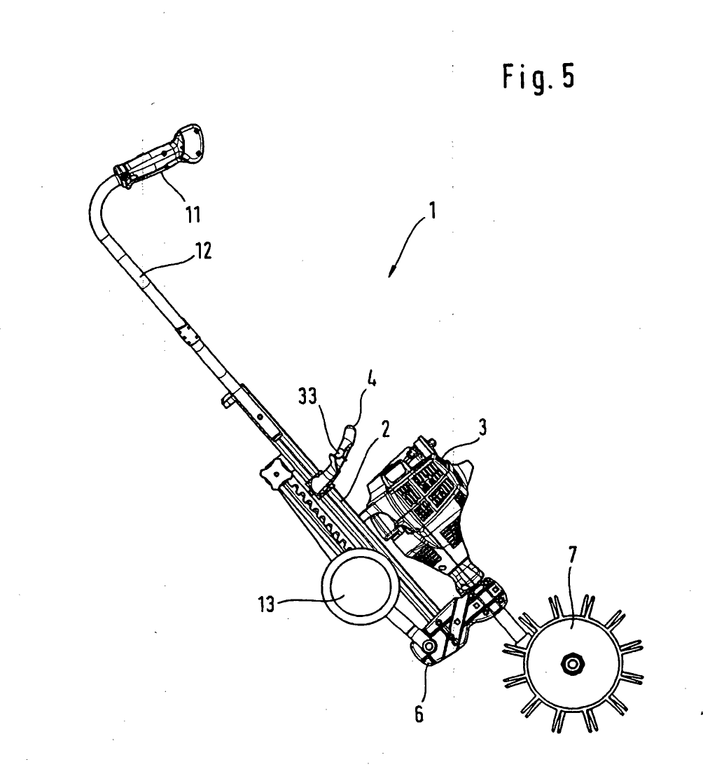

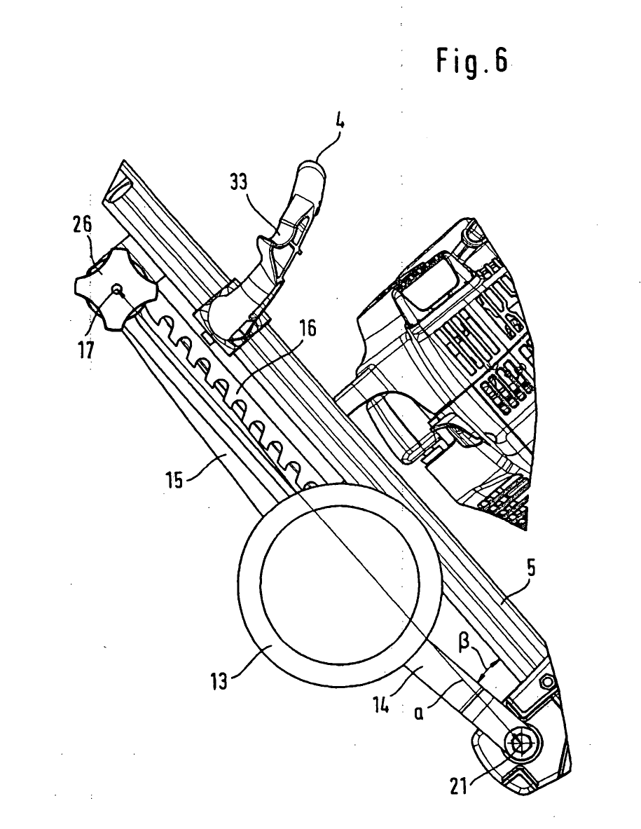

In FIGS. 5 and 6, the sweeper 1 is shown in its operating position. The transport wheel 13 is disposed in the region of the frame 2 and does not come in contact engagement with the ground when the sweeper 1 is in its work position. The fixing screw 26 is arranged at a first attachment point 17 which is disposed in a first detent recess 22 shown in FIG. 2. The first attachment point 17 is at a distance (a) to the rotational axis 21 of the first strut 14 and this distance (a) is greater than the distances (b, b′) of the second attachment points (18, 18′) to the rotational axis 21. The first strut 14 and the longitudinal direction 8 of the frame 2 conjointly define an angle β. The angle β is small and is especially almost 0° so that the first strut 14 runs approximately parallel to the rod 5 of the frame 2. The second strut 15 also runs approximately parallel to the rod 5.

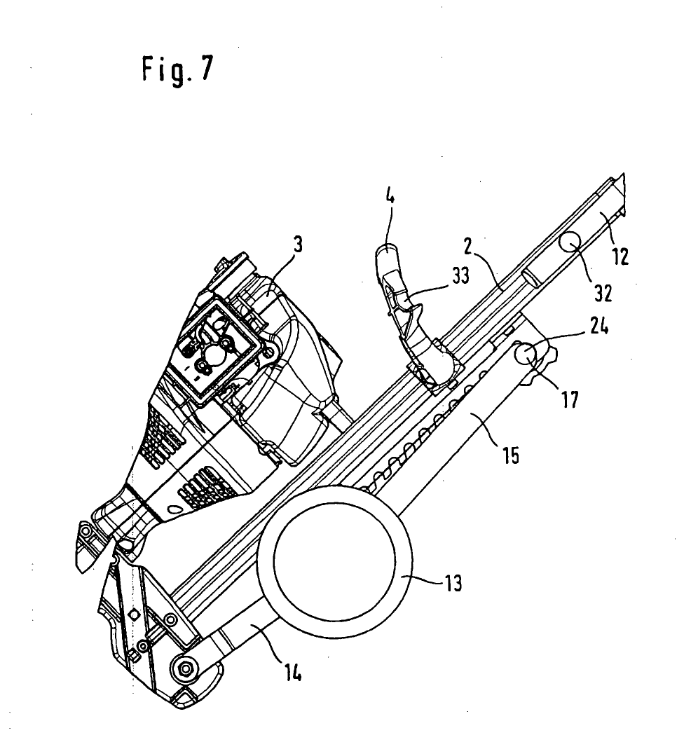

As shown in FIG. 7, a bolt 24 is arranged in the detent recess 22 at the first attachment point 17. The bolt 24 includes an internal thread so that the fixing screw 26 can be threaded into the bolt 24. At the end which faces away from the fixing screw 26, the bolt 24 is configured to be widened so that a stop is formed against the rail 16. For transporting the sweeper 1, the transport wheel 13 is brought into the position shown in FIGS. 5 and 6. The handle tubes 12 can then be folded over and come to rest in supports 33 which are formed laterally on the handle 4. The sweeper 1 can then be lifted at the handle 4.

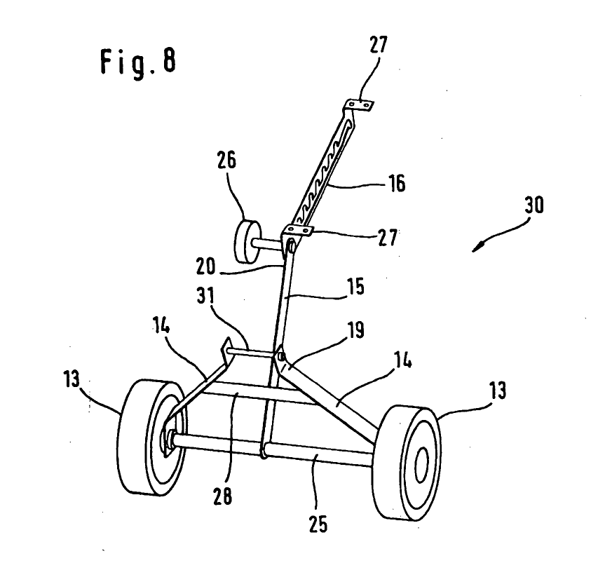

FIG. 8 is a perspective view of a transport device 30. The transport device 30 can be subsequently fixed or retrofitted to a work apparatus such as a sweeper 1 or a motorized cultivator or the like. The configuration of the transport device 30 corresponds to the arrangement shown in FIGS. 1 to 7. The transport device 30 has two symmetrically arranged transport wheels 13 which are mounted on a common axle 25. The axle 25 is held by two first struts 14 which are fixed on the axle 25 in the region of the transport wheels 13 and are bent toward each other. The end 19 of the two first struts 14 faces away from the transport wheel 13. At this end, a bolt 31 is mounted which extends parallel to the axle 25 and with which the first struts 14 can be rotatably fixed to the work apparatus. The two first struts 14 are connected approximately midway by a transverse strut 28 for stabilization. The axle 25 is held midway by a second strut 15. A fixing screw 26 is arranged on the end 20 of the second strut 15 which faces away from the axle 25. The fixing screw 26 is guided in a rail 16. The rail 16 has detent recesses. At its two ends, the rail 16 has mounting brackets 27 for fixing to a work apparatus.

It is understood that the foregoing description is that of the preferred embodiments of the invention and that various changes and modifications may be made thereto without departing from the spirit and scope of the invention as defined in the appended claims.

1. A portable handheld work apparatus arrangement comprising:
a work apparatus including a drive motor and a work tool driven by said drive motor;
at least one transport wheel;
first and second struts for connecting said transport wheel to said work apparatus;
said first strut having a first end facing away from said transport wheel and said first strut being rotatably mounted on said work apparatus at said first end; and,
said second strut having a first end facing away from said transport wheel and said second strut being fixable at said first end thereof on said work apparatus at at least first and second attachment points.

2. The portable handheld work apparatus arrangement of claim 1, wherein said first strut defines an axis of rotation at said first end thereof; said first and second attachment points are at first and second distances (a, b) from said axis of rotation; and, said first and second distances (a, b) are different from each other.

3. The portable handheld work apparatus arrangement of claim 1, wherein said work apparatus has a frame and said transport wheel is in the region of said frame when said second strut is fixed at said first attachment point.

4. The portable handheld work apparatus arrangement of claim 3, wherein said transport wheel is at a distance (c, c′) from said frame when said second strut is fixed at said second attachment point.

5. The portable handheld work apparatus arrangement of claim 4, wherein said attachment points are configured as respective detent recesses.

6. The portable handheld work apparatus arrangement of claim 5, wherein said first attachment point is configured as a detent recess closed toward said second strut.

7. The portable handheld work apparatus arrangement of claim 6, wherein said second attachment point is configured as a detent recess open toward said second strut.

8. The portable handheld work apparatus arrangement of claim 7, further comprising a bolt extending transversely to said second strut; and, said bolt coacting with said first and second detent recess to fix said transport wheel in position relative to said frame.

9. The portable handheld work apparatus arrangement of claim 8, further comprising a fixing screw coacting with said bolt to releasably fix said second strut in one of said detent recesses.

10. The portable handheld work apparatus arrangement of claim 9, further comprising a rail fixedly connected to said work apparatus and said detent recesses being formed in said rail.

11. The portable handheld work apparatus arrangement of claim 9, further comprising a rail; and, said rail and said first strut being releasably fixed on said work apparatus.

12. The portable handheld work apparatus arrangement of claim 1, further comprising attachment points in addition to said second attachment point to define a plurality of second attachment points at respectively different distances from said axis of rotation at said first end of said first strut.

13. The portable handheld work apparatus arrangement of claim 1, wherein said transport wheel is a first transport wheel and said arrangement further comprises a second transport wheel and an axle common to said first and second transport wheels; and, an additional first strut; and, said axle is held by said two first struts and said second strut.

14. The portable handheld work apparatus arrangement of claim 1, wherein said work apparatus is a sweeper or motorized cultivator.

15. A transport device for a portable handheld work apparatus, the transport device comprising:
at least one transport wheel;
first and second struts connected to said transport wheel;
said second strut having a first end facing away from said transport wheel; and,
a rail arranged on said first end of said second strut and said rail having at least two attachment points.

16. The transport device of claim 15, wherein said attachment points are configured as detent recesses.

17. The transport device of claim 15, wherein said first strut has a first end facing away from said transport wheel; and, wherein said transport device further comprises a bolt arranged at said first end of said first strut.

18. The transport device of claim 15, wherein said rail has a detent recess formed therein closed in a direction toward said second strut.

19. The transport device of claim 15, wherein said rail has a plurality of detent recesses formed therein open toward said second strut.
